(19) United States
(12) Patent Application Publication
(10) Pub. No.: US 2022/0402222 A1
(43) Pub. Date: Dec. 22, 2022

(54) MOLD FOR ULTRA-THICK WALLED U-SHAPED COMPOSITE PRODUCT WITH DEEP CAVITY

(71) Applicant: SHANGHAI CEDAR COMPOSITES TECHNOLOGY CO., LTD., Shanghai (CN)

(72) Inventors: Guoqiang ZHANG, Shanghai (CN); Jiaqiang ZHU, Shanghai (CN); Bin WANG, Shanghai (CN); Jianlan LUO, Shanghai (CN); Hao SUN, Shanghai (CN); Jie WU, Shanghai (CN); Bangshui YU, Shanghai (CN)

(73) Assignee: SHANGHAI CEDAR COMPOSITES TECHNOLOGY CO., LTD., Shanghai (CN)

(21) Appl. No.: 17/279,325

(22) PCT Filed: Jan. 14, 2021
(86) PCT No.: PCT/CN2021/071642

§ 371 Date: Mar. 24, 2021

(30) Foreign Application Priority Data
Dec. 26, 2020 (CN) 202011569812.X

(51) Int. Cl. B29C 70/54

(52) U.S. Cl. CPC B29C 70/54; B29K 2905/12

(57) ABSTRACT

A mold for an ultra-thick walled U-shaped composite product with a deep cavity includes an upper mold cavity, a lower mold cavity, a slidable side-drawing insert, and an auxiliary mold clamping structure. The auxiliary mold clamping structure includes a first auxiliary mold clamping insert and a second auxiliary mold clamping insert. The first auxiliary mold clamping insert is fixed on the lower mold cavity, and the second auxiliary mold clamping insert is fixed on the slidable side-drawing insert. The slidable side-drawing insert is located on a side of an integral structure formed after the upper mold cavity is engaged with the lower mold cavity, and the slidable side-drawing insert longitudinally slides along the lower mold cavity. The ultra-thick walled U-shaped composite product is formed and located between the upper mold cavity, the lower mold cavity, and the slidable side-drawing insert.

### CROSS REFERENCE TO THE RELATED APPLICATIONS

This application is the national phase entry of International Application No. PCT/CN2021/071642, filed on Jan. 14, 2021, which is based upon and claims priority to Chinese Patent Application No. 202011569812.X, filed on Dec. 26, 2020, the entire contents of which are incorporated herein by reference.

### TECHNICAL FIELD

The present invention relates to a mold for a composite product, and more particularly, to a mold for an ultra-thick walled U-shaped composite product with a deep cavity. According to the present invention, a formed product has a uniform wall thickness and a smooth surface without a step. This solves the problems that the product with a deep cavity has poor surface quality caused by nonuniform heat transfer of an ultra-thick walled mold, inserts of the mold are prone to upsetting onto their side due to excessive heights, and a mold clamping cannot be fulfilled due to insufficient manual thrust.

### BACKGROUND

To prevent ordinary products with deep cavities from deformation, traditional molds for these products typically have an increased wall thickness with an increase in the length, depth, and height of the products. This will affect the heat transfer of the molds due to the increase of the wall thickness. As for traditional molds for ultra-thick walled products with deep cavities, the thickness of prepregs at room temperature is greater than an actual size of the products, and in this case, the mold clamping cannot be fulfilled, and there will be steps on the surfaces of the products at positions of the mold clamping. Furthermore, side-drawing inserts of the traditional molds are only limited by slide ways. When drawn to extreme positions for mold opening, the side-drawing inserts are prone to upsetting onto their side, causing potential safety hazards. At room temperature, if the molds for composite products are clamped by means of manual thrust, they cannot be clamped due to insufficient manual thrust; and if the molds for composite products are clamped by means of forces from lead screws, the inserts and costs will increase.

### SUMMARY

To solve the above problems, an objective of the present invention is to provide a mold for an ultra-thick walled U-shaped composite product with a deep cavity. A formed product has a uniform wall thickness and a smooth surface without a step. This solves the problems that the product with a deep cavity has poor surface quality caused by nonuniform heat transfer of an ultra-thick walled mold, inserts of the mold are prone to upsetting onto their side due to excessive heights, and a mold clamping cannot be fulfilled due to insufficient manual thrust.

To solve the above technical problems, the present invention adopts the following technical solution. A mold for an ultra-thick walled U-shaped composite product with a deep cavity includes:

an upper mold cavity, a lower mold cavity, a slidable side-drawing insert, and an auxiliary mold clamping structure.

The auxiliary mold clamping structure includes a first auxiliary mold clamping insert and a second auxiliary mold clamping insert.

The first auxiliary mold clamping insert is fixed on the lower mold cavity, and the second auxiliary mold clamping insert is fixed on the slidable side-drawing insert.

The slidable side-drawing insert is located on a side of an integral structure formed after the upper mold cavity is engaged with the lower mold cavity, and the slidable side-drawing insert longitudinally slides along the lower mold cavity.

A formed U-shaped composite product is located between the upper mold cavity, the lower mold cavity, and the slidable side-drawing insert.

In an embodiment of the present invention, the first auxiliary mold clamping insert is fixed on the lower mold cavity, and the second auxiliary mold clamping insert is fixed on the slidable side-drawing insert. The slidable side-drawing insert slides back and forth. During a spreading of a material, the first auxiliary mold clamping insert and the second auxiliary mold clamping insert are movable, and the second auxiliary mold clamping insert slides under the first auxiliary mold clamping insert. After the spreading of the material, the second auxiliary mold clamping insert is gradually clamped with the first auxiliary mold clamping insert during a mold clamping, and then the mold clamping is achieved with assistance of a pressing force of a screw.

In an embodiment of the present invention, a hollow protrusion of the upper mold cavity is formed by welding steel plates to serve as a cavity, and one side of the protrusion is higher than the other side of the protrusion.

In an embodiment of the present invention, an integral steel plate is processed to serve as the bottom of the lower mold cavity. Hollow three-dimensional frames formed by welding steel plates are spliced to serve as two sides of the lower mold cavity.

In an embodiment of the present invention, plate ribs for improving strength are arranged in the hollow three-dimensional frames of the two sides of the lower mold cavity.

In an embodiment of the present invention, the slidable side-drawing insert includes a hollow three-dimensional square insert formed by welding steel plates and a slider.

In an embodiment of the present invention, the hollow three-dimensional square insert and the slider are positioned by a positioning groove, and are connected through a screw.

In an embodiment of the present invention, a groove for the slider to slide back and forth is arranged on the lower mold cavity. The groove is an insert embedded in the lower mold cavity, and the insert is made from a hard brass alloy inlaid with graphite.

In an embodiment of the present invention, the upper mold cavity, the lower mold cavity, and the slidable side-drawing insert are made from Q235 steel through welding, and the auxiliary mold clamping structure is made from S45C steel through processing.

The present invention has the following advantages. The mold for an ultra-thick walled U-shaped composite product with a deep cavity overcomes the difficulty in clamping a mold for an ultra-thick walled composite product with a deep cavity, and enables a formed product to have a uniform wall thickness and a smooth surface without a step. The thin-walled spliced structure solves the problem that the product with a deep cavity has poor surface quality caused by nonuniform heat transfer of an ultra-thick walled mold. The auxiliary mold clamping structure solves the problems that the inserts are prone to upsetting onto their side due to excessive heights and the mold clamping cannot be fulfilled due to insufficient manual thrust.

### BRIEF DESCRIPTION OF THE DRAWINGS

FIG. 1 is a diagram of the structure of a composite product formed by employing the structure of the present invention.

FIG. 2A is a diagram of the structure of the present invention.

FIG. 2B shows a partially enlarged view of FIG. 2A.

FIG. 3A is a diagram of the structure of a first auxiliary mold clamping insert according to the present invention.

FIG. 3B shows a front view of FIG. 3A.

FIG. 3C shows a top view of FIG. 3A.

FIG. 3D shows a left view of FIG. 3A.

FIG. 4A is a diagram of the structure of a second auxiliary mold clamping insert according to the present invention.

FIG. 4B shows a front view of FIG. 4A.

FIG. 4C shows a top view of FIG. 4A.

FIG. 4D shows a left view of FIG. 4A.

FIG. 5 is a diagram of the structure of plate ribs for improving strength provided in the hollow three-dimensional frames according to the present invention.

FIG. 6 is a diagram of the structure of an upper mold cavity according to the present invention.

FIG. 7 is a diagram of the structure of a lower mold cavity according to the present invention.

FIG. 8 is a diagram of the structure of a slidable side-drawing insert according to the present invention.

FIG. 9A shows a structural diagram of a state at which it is ready to perform the mold clamping according to the present invention.

FIG. 9B shows a partially enlarged view of FIG. 9A.

FIG. 10A shows a structural diagram of a state at which the spreading of the material is performed according to the present invention.

FIG. 10B shows a partially enlarged view of FIG. 10A.

FIG. 11A shows a structural diagram of a state at which the mold is clamped after the spreading of the material according to the present invention.

FIG. 11B shows a partially enlarged view of FIG. 11A.

FIG. 12A shows a structural diagram of a state at which the mold is open according to the present invention.

FIG. 12B shows a partially enlarged view of FIG. 12A.

In the figures:

1. upper mold cavity, 2. lower mold cavity, 3. slidable side-drawing insert, 4. auxiliary mold clamping structure, 5. plate rib, 6. composite product, 401. first auxiliary mold clamping insert, 402. second auxiliary mold clamping insert.

### DETAILED DESCRIPTION OF THE EMBODIMENTS

The technical solutions of the present invention are described in detail below based on the preferred embodiments with reference to the drawings.

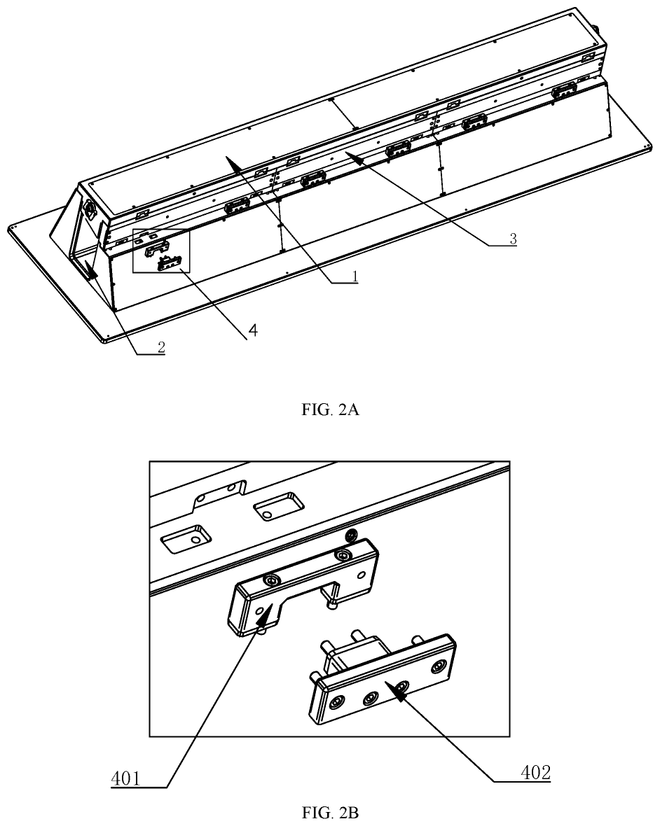

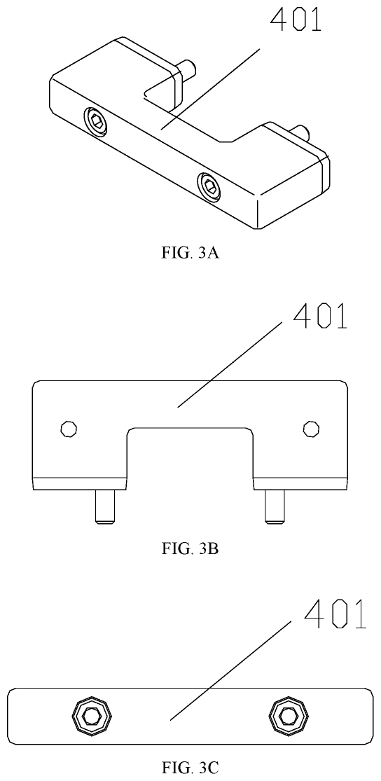

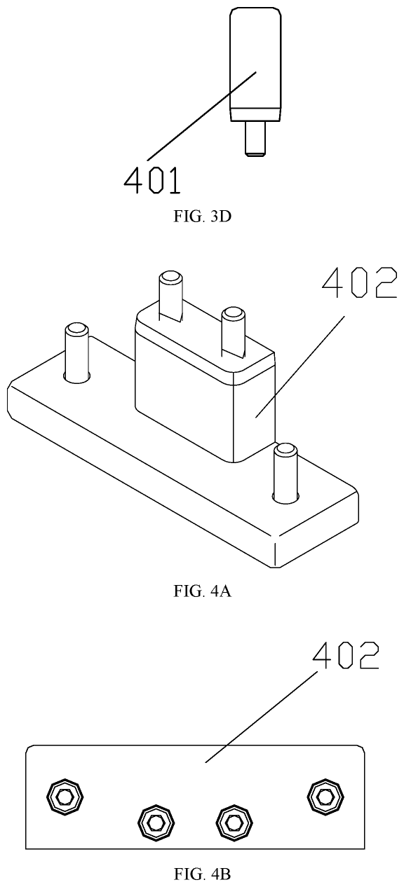

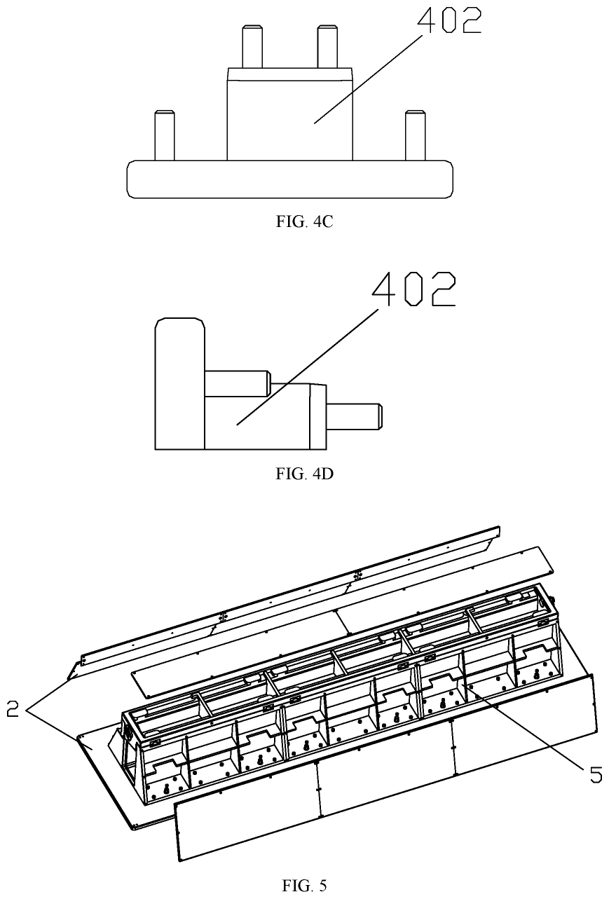

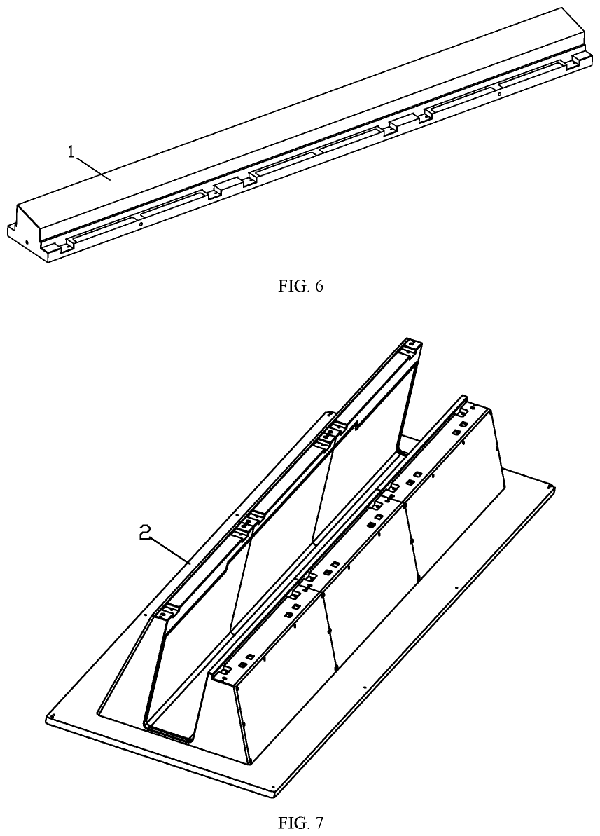

FIG. 2A is a diagram of the structure of the present invention. FIG. 2B shows a partially enlarged view of FIG. 2A. FIG. 3A is a diagram of the structure of a first auxiliary mold clamping insert according to the present invention. FIG. 4A is a diagram of the structure of a second auxiliary mold clamping insert according to the present invention. FIG. 6 is a diagram of the structure of an upper mold cavity according to the present invention. FIG. 7 is a diagram of the structure of a lower mold cavity according to the present invention. FIG. 8 is a diagram of the structure of a slidable side-drawing insert according to the present invention. As shown in these figures, a mold for an ultra-thick walled U-shaped composite product with a deep cavity provided by the present invention includes the upper mold cavity 1, the lower mold cavity 2, the slidable side-drawing insert 3, and the auxiliary mold clamping structure 4. The auxiliary mold clamping structure 4 includes the first auxiliary mold clamping insert 401 and the second auxiliary mold clamping insert 402. The first auxiliary mold clamping insert 401 is fixed on the lower mold cavity 2, and the second auxiliary mold clamping insert 402 is fixed on the slidable side-drawing insert 3.

The slidable side-drawing insert 3 is located on a side of an integral structure formed after the upper mold cavity 1 is engaged with the lower mold cavity 2, and the slidable side-drawing insert 3 longitudinally slides along the lower mold cavity 2.

The formed U-shaped composite product 6 is located between the upper mold cavity 1, the lower mold cavity 2, and the slidable side-drawing insert 3.

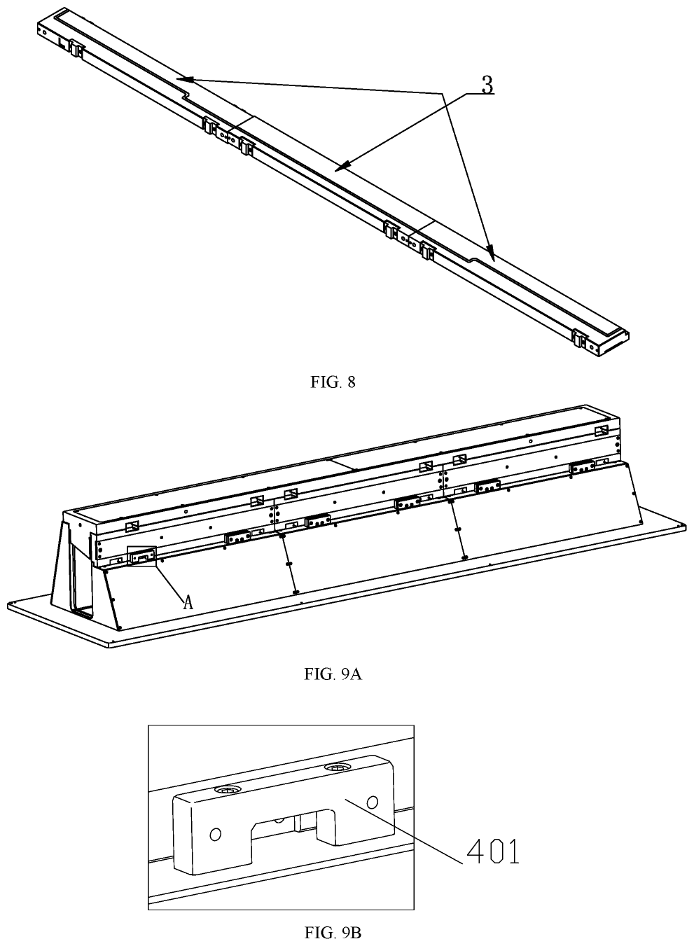

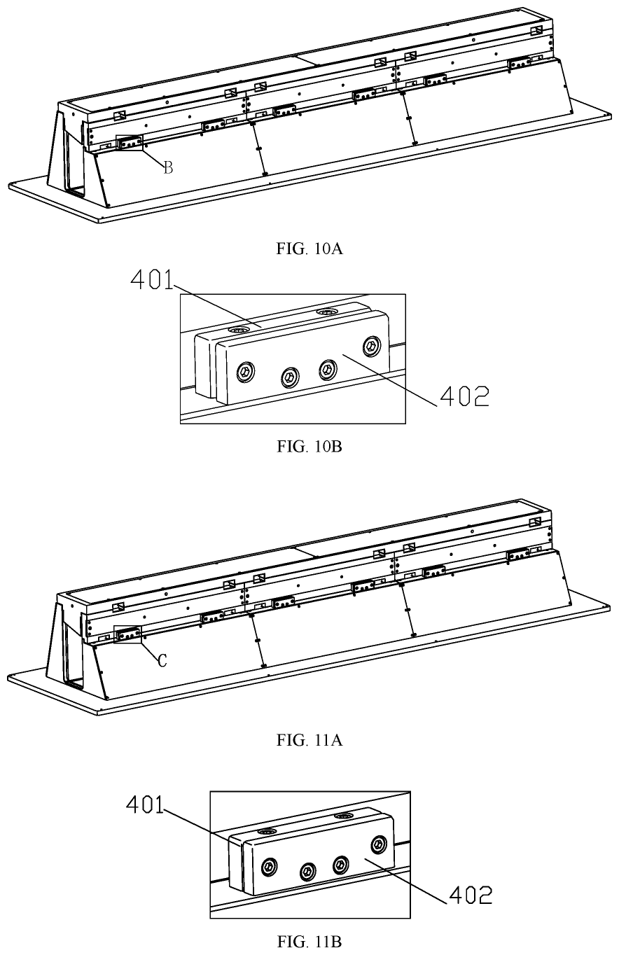

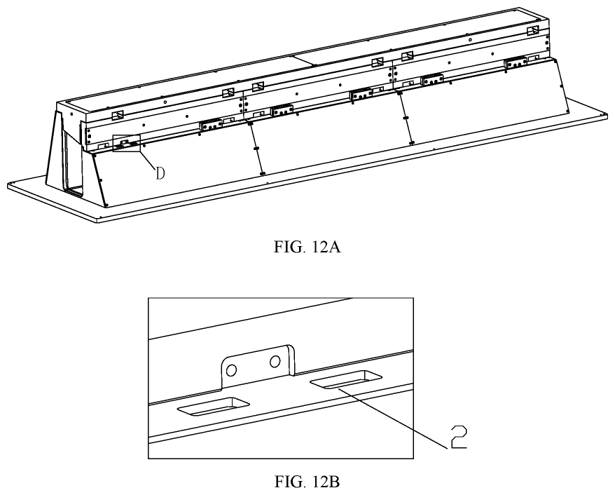

FIG. 3A shows the diagram of the structure of the first auxiliary mold clamping insert according to the present invention. FIG. 3B shows a front view of FIG. 3A. FIG. 3C shows a top view of FIG. 3A. FIG. 3D shows a left view of FIG. 3A. FIG. 4A shows the diagram of the structure of the second auxiliary mold clamping insert according to the present invention. FIG. 4B shows a front view of FIG. 4A. FIG. 4C shows a top view of FIG. 4A. FIG. 4D shows a left view of FIG. 4A. Referring to FIG. 8, FIG. 9A, FIG. 10A, FIG. 11A, and FIG. 12A, the first auxiliary mold clamping insert 401 is fixed on the lower mold cavity 2, and the second auxiliary mold clamping insert 402 is fixed on the slidable side-drawing insert 3. The slidable side-drawing insert 3 slides up and down. During spreading of the material, the first auxiliary mold clamping insert 401 and the second auxiliary mold clamping insert 402 are movable, and the second auxiliary mold clamping insert 402 slides under the first auxiliary mold clamping insert 401. After the spreading of the material, the second auxiliary mold clamping insert 402 is gradually clamped with the first auxiliary mold clamping insert 401 during mold clamping, and then the mold clamping is achieved with assistance of a pressing force of a screw.

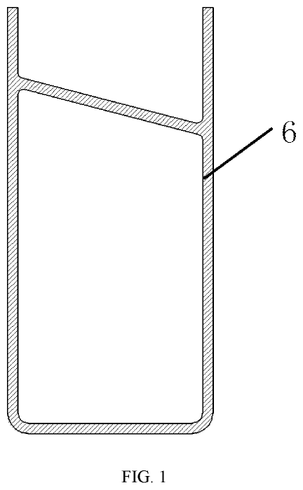

A hollow protrusion of the upper mold cavity 1 is formed by welding steel plates to serve as a cavity, and one side of the protrusion is higher than the other side of the protrusion. FIG. 1 is a diagram of the structure of a composite product formed by employing the structure of the present invention. Referring to FIG. 1 and FIG. 6, according to the present invention, one side of a transom inside the manufactured composite product 6 is higher than the other side.

FIG. 5 is a diagram of the structure of plate ribs for improving strength provided in the hollow three-dimensional frames according to the present invention. As shown in FIG. 5, an integral steel plate is processed to serve as the bottom of the lower mold cavity 2. The hollow three-dimensional frames formed by welding steel plates are spliced to serve as two sides of the lower mold cavity 2. The plate ribs 5 for improving strength are arranged in the hollow three-dimensional frames of two sides of the lower mold cavity 2. The hollow three-dimensional frames of two sides of the lower mold cavity 2 generally have a relatively small thickness of 10-15 mm. A mold with a relatively large length is typically increased in the thickness to avoid deformation, and this will cause nonuniform heat conduction of the mold. As a result, shrinkage porosity will be generated on the surface of the product. By adoption of the thin-walled structure of the present invention, the wall thickness of the mold is decreased, and the strength of the mold is improved by the plate ribs. In this way, heat conduction of the mold is ensured to be uniform, and the structural strength of the mold is ensured to avoid the deformation.

The slidable side-drawing insert 3 includes a hollow three-dimensional square insert formed by welding steel plates and a slider. The hollow three-dimensional square insert and the slider are fixedly connected together through a screw or are integrally formed.

A groove for the slider to slide up and down is arranged on the lower mold cavity 2, and the groove is made from the embedded brass.

In a specific implementation, the upper mold cavity 1, the lower mold cavity 2, and the slidable side-drawing insert 3 of the present invention are made from Q235 steel through welding, and the auxiliary mold clamping structure 4 of the present invention is made from S45C steel through processing.

FIG. 8 is a diagram of the structure of the slidable side-drawing insert according to the present invention. As shown in FIG. 8, the slidable side-drawing insert 3 includes a hollow three-dimensional square insert formed by welding steel plates and a slider. The hollow three-dimensional square insert and the slider are fixedly connected together through a screw or are integrally formed. The slidable side-drawing insert 3 is located on a side of the integral structure formed after the upper mold cavity 1 is engaged with the lower mold cavity 2, and the slidable side-drawing insert 3 longitudinally slides along the lower mold cavity 2.

If the hollow three-dimensional square insert and the slider are not integrally formed, a positioning groove is formed in the slidable side-drawing insert 3, and the slider is arranged in the positioning groove after being processed according to a size and then is fixed by a screw.

The groove for the slider to slide up and down is arranged on the lower mold cavity 2, and the groove is made from the embedded brass.

The upper mold cavity, the lower mold cavity, and the slidable side-drawing insert are made from the Q235 steel through welding, and the auxiliary mold clamping structures 4 are made from the S45C steel through processing.

The slidable side-drawing insert 3 is located on a side of the integral structure formed after the upper mold cavity 1 is engaged with the lower mold cavity 2, and the slidable side-drawing insert 3 longitudinally slides along the lower mold cavity 2.

The first auxiliary mold clamping insert 401 is fixed to the lower mold cavity to limit the second auxiliary mold clamping insert 402; and in this way, the slidable side-drawing insert 3 is limited to only slide in a side-drawing direction without turning over, thereby reducing a potential safety hazard. The second auxiliary mold clamping insert 402 is fixed to the slidable side-drawing insert 3. When the mold clamping is performed at room temperature, the screw can be fastened to the first auxiliary mold clamping insert 401 through the second auxiliary mold clamping insert 402 to generate a tight locking force, so as to provide a mold clamping force for the slidable side-drawing insert 3 to assist in achieving the mold clamping.

FIG. 9A shows a structural diagram of a state at which it is ready to perform the mold clamping according to the present invention. FIG. 9B shows a partially enlarged view of FIG. 9A. FIG. 10A shows a structural diagram of a state at which the spreading of the material is performed according to the present invention. FIG. 10B shows a partially enlarged view of FIG. 10A. FIG. 11A shows a structural diagram of a state at which the mold is clamped after the spreading of the material according to the present invention. FIG. 11B shows a partially enlarged view of FIG. 11A. FIG. 12A shows a structural diagram of a state at which the mold is open according to the present invention. FIG. 12B shows a partially enlarged view of FIG. 12A. As shown in these figures, the second state and the third state are states when the mold is in use, and in these cases, the slidable side-drawing insert will not upset onto its side. In the fourth state, no auxiliary mold clamping insert is used, and in this case, during the spreading of the material, the inserts on an upper mold are not clamped, and the slidable side-drawing insert is in a free state and is prone to upsetting onto its side, causing a potential safety hazard. Regarding this, a gap is formed between two auxiliary inserts during the spreading of the material, so that the upper mold cannot contact a material during the mold clamping. This provides a assistance for safety. Moreover, no gap is formed after the spreading of the material. This provides a assistance for the mold clamping.

The difficulty in making the whole product lies in forming. A cold material and a hot material for the composite product have different thicknesses. The thickness of the cold material is large, and the cold material will be deformed after being heated, causing the thickness to change. This problem is solved by means of sliding of the side-drawing insert.

To prevent an ordinary product with a deep cavity from deformation, a conventional mold for this product is typically increased in wall thickness with an increase in the length, depth, and height of the product. This will affect heat transfer of the mold due to the increase of the wall thickness. The hollow three-dimensional thin-walled structure solves the problem that the product with a deep cavity has poor surface quality caused by nonuniform heat transfer of an ultra-thick walled mold.

The slidable side-drawing insert of a U-shaped box-type mold overcomes the difficulty in clamping the mold for an ultra-thick walled composite product made by means of an autoclave process, and enables a formed product to have a uniform wall thickness and a smooth surface without a step. A slide way made from high-strength brass alloys (CAC304) and inlaid with MoS2 is used to reduce the side-drawing sliding resistance. The operating principle of the slidable side-drawing insert of the U-shaped box-type mold is as follows: the thickness of a prepreg at room temperature is greater than the actual size of the product, and in this case, the mold clamping cannot be fulfilled. By adoption of the slidable side-drawing insert, the prepreg will be softened after the mold is heated in an autoclave, so that the side-drawing insert is smoothly clamped with the upper mold cavity and lower mold cavity of the mold under a pressure of 1.0 MPa through a vacuum bag.

The above describes the basic principles, main features and advantages of the present invention. Those skilled in the art should know that the present invention is not limited by the above embodiments. The above embodiments and the specification merely describe the principle of the present invention. The present invention further has various changes and improvements without departing from the spirit and scope of the present invention, and these changes and improvements shall fall within the scope of protection of the present invention. The scope of protection of the present invention is limited by the appended claims and the legal equivalents thereof.

What is claimed is:

1. A mold for an ultra-thick walled U-shaped composite product with a deep cavity, comprising:
an upper mold cavity, a lower mold cavity, a slidable side-drawing insert, and an auxiliary mold clamping structure; wherein,
the auxiliary mold clamping structure comprises a first auxiliary mold clamping insert and a second auxiliary mold clamping insert;
the first auxiliary mold clamping insert is fixed on the lower mold cavity, and the second auxiliary mold clamping insert is fixed on the slidable side-drawing insert;
the slidable side-drawing insert is located on a side of an integral structure formed after the upper mold cavity is engaged with the lower mold cavity, and the slidable side-drawing insert longitudinally slides along the lower mold cavity; and
the ultra-thick walled U-shaped composite product is formed and located between the upper mold cavity, the lower mold cavity, and the slidable side-drawing insert.

2. The mold according to claim 1, wherein the first auxiliary mold clamping insert is fixed on the lower mold cavity, and the second auxiliary mold clamping insert is fixed on the slidable side-drawing insert; the slidable side-drawing insert slides back and forth longitudinally; during a spreading of a material, the first auxiliary mold clamping insert and the second auxiliary mold clamping insert are movable, and the second auxiliary mold clamping insert slides under the first auxiliary mold clamping insert; and after the spreading of the material, the second auxiliary mold clamping insert is gradually clamped with the first auxiliary mold clamping insert during a mold clamping, and then the mold clamping is achieved with assistance of a pressing force of a screw.

3. The mold according to claim 1, wherein a hollow protrusion of the upper mold cavity is formed by welding steel plates to serve as a cavity, and one a first side of the hollow protrusion is higher than the other a second side of the hollow protrusion.

4. The mold according to claim 1, wherein an integral steel plate is processed to serve as a bottom of the lower mold cavity; and hollow three-dimensional frames formed by welding steel plates are spliced to serve as two sides of the lower mold cavity.

5. The mold according to claim 4, wherein plate ribs for improving a strength are arranged in the hollow three-dimensional frames of the two sides of the lower mold cavity.

6. The mold according to claim 1, wherein the slidable side-drawing insert comprises a hollow three-dimensional square insert and a slider, wherein the hollow three-dimensional square insert is formed by welding steel plates.

7. The mold according to claim 6, wherein the hollow three-dimensional square insert and the slider are positioned by a positioning groove, and the hollow three-dimensional square insert and the slider are fixedly connected together through a screw.

8. The mold according to claim 6, wherein a groove for the slider to slide back and forth is arranged on the lower mold cavity; the groove is an insert embedded in the lower mold cavity, and the insert is made from a hard brass alloy inlaid with graphite.

9. The mold according to claim 1, wherein the upper mold cavity, the lower mold cavity, and the slidable side-drawing insert are made from Q235 steel through welding, and the auxiliary mold clamping structure is made from S45C steel through processing.

10. The mold according to claim 7, wherein a groove for the slider to slide back and forth is arranged on the lower mold cavity; the groove is an insert embedded in the lower mold cavity, and the insert is made from a hard brass alloy inlaid with graphite.
